(19) United States
(12) Patent Application Publication
(10) Pub. No.: US 2008/0106199 A1
(43) Pub. Date: May 8, 2008

(54) Plasma display module, method of combining plasma display panel and chassis, and method of separating chassis from plasma display panel

(76) Inventor: Hyuk Kim, Suwon-si (KR)

Correspondence Address: ROBERT E. BUSHNELL, 1522 K STREET NW, SUITE 300, WASHINGTON, DC, 20005-1202, US

(21) Appl. No.: 11/898,213

(22) Filed: Sep. 10, 2007

(30) Foreign Application Priority Data
Nov. 2, 2006 (KR) 10-2006-0107993

(51) Int. Cl. H01J 17/49; H01J 9/02

(52) U.S. Cl. 313/582; 445/24

(57) ABSTRACT

The provided is a new structure of a plasma display module, in which a plasma display panel (PDP) and a chassis can be separated promptly and easily. The plasma display module includes a PDP which displays images, a chassis which is disposed adjacent to a rear surface of the PDP, a hinge coupled to the chassis. An adhesive member such as a double-sided tape is disposed between the hinge and the rear surface of the PDP. During coupling and decoupling processes of the PDP and the chassis, the hinge rotates in order to prevent interference between the PDP and the chassis. The present invention also provides a method of combining a PDP and a chassis, and a method of separating a chassis from a PDP.

### CLAIM OF PRIORITY

This application makes reference to, incorporates the same herein, and claims all benefits accruing under 35 U.S.C. § 119 from an application for PLASMA DISPLAY MODULE, METHOD OF ADHERING PLASMA DISPLAY PANEL TO CHASSIS AND METHOD OF SEPARATING PLASMA DISPLAY PANEL TO CHASSIS earlier filed in the Korean Intellectual Property Office on the 2 Nov. 2006 and there duly assigned Serial No. 10-2006-0107993.

### BACKGROUND OF THE INVENTION

1. Field of the Invention

The present invention relates to a plasma display module, a method of combining a plasma display panel (PDP) and a chassis, and a method of separating a chassis from a PDP. More particularly, the present invention relates to a plasma display module in which a chassis can be easily and promptly separated from a PDP of the plasma display module, a method of combining a PDP and a chassis, and a method of separating a chassis from a PDP.

2. Description of the Related Art

A plasma display module is a flat panel display device which displays images using a gas discharge effect. Due to its thin and large screen having a wide viewing angle and a high-definition, the plasma display module recently has received much attention as a large-scale flat panel display device. The plasma display module includes a plasma display panel (PDP) on which images are displayed using a gas discharge effect, and a chassis which supports the PDP. A plurality of circuit boards to drive the PDP are installed on the rear surface of the chassis, and the circuit boards and the PDP are electrically connected by a plurality of signal transmitting means such as tape carrier packages (TCPs) or flexible printed circuits (FPCs).

It is necessary to inspect the plasma display module, in which the PDP and the chassis are assembled together, in order to investigate whether a defect has occurred in the TCPs or FCPs which includes a plurality in integrated circuits (ICs). If a defect is detected in the TCPs or FCPs during the inspection, the chassis has to be separated from the PDP in order to repair the defect.

In the contemporary technology, a chassis is assembled with a PDP through a double-sided tape. Therefore, in order to separate the chassis from the PDP, it is necessary to remove the double-sided tape or to weaken the strength of the double-sided tape. In this case, heating process is mostly employed to weaken the strength of the double-sided tape. In other words, the plasma display module is heated at a certain temperature until the strength of the double-sided tape is weakened and the chassis is easily separated from the PDP. The heating method, however, requires a large amount of time, and can produce smoke and odor during the process. The PDP or the chassis can be damaged due to the heat, and the chassis has to be replaced after the heating process.

### SUMMARY OF THE INVENTION

The provided is a plasma display module that includes the plasma display panel, the chassis, and a hinge coupled to each of the chassis and the plasma display panel through an adhesive member, a method of combining a plasma display panel (PDP) and a chassis, and a method of separating a chassis from a PDP.

According to an aspect of the present invention, there is provided a plasma display module that includes a plasma display panel having a front surface and a rear surface where an image is displayed on the front surface, a chassis arranged adjacent to the rear surface, a hinge having a first arm and a second arm where the second arm is coupled to the chassis, and an adhesive member disposed between the rear surface of the plasma display panel and the first arm of the hinge to attach the first arm of the hinge on the rear surface of the plasma display panel.

The plasma display module may further include a coupling member that couples the second arm of the hinge onto the chassis. The coupling member may include a screw boss disposed between the second arm of the hinge and the chassis, and a screw having a screw body and a screw head. The screw boss has an internal screw thread and is fixed on the chassis. The screw body passes through the second arm of the hinge, and is coupled into the internal screw thread of the screw boss. The coupling member may further include a washer disposed between the screw head and the second arm of the hinge.

The adhesive member may be attached on a lateral edge portion of the rear surface of the plasma display panel. Only one adhesive member may be attached on the first arm of the hinge.

The hinge may include a pivot disposed between the first arm and the second arm. Each of the first arm and the second arm has a first portion and a second portion. Each of the first portion of the first arm and the first portion of the second arm may be rotatably connected to the pivot. The adhesive member may be attached on the second portion of the first arm, and the second portion of the second arm may be coupled to the chassis.

The first arm may have a shape of a flat plate, and the second arm may have a cross-sectional shape of an L-shape. Each of the first arm and the second arm may have a cross-sectional shape of an L-shape. Each of the first portion of the first arm and the first portion of the second arm may have a shape of an arc, and each of the second portion of the first arm and the second portion of the second arm may have a shape of a flat plate. The hinge may be made of a material including aluminum.

According to another aspect of the present invention, there is provided a method of combining a PDP and a chassis. The method includes steps of attaching a first surface of an adhesive member on a rear surface of the plasma display panel, attaching a second surface of the adhesive member on a first arm of a hinge, and coupling a second arm of the hinge onto the chassis. An image is displayed on a front surface of the plasma display panel.

The step of coupling the second arm of the hinge onto the chassis may include a step of engaging a coupling member on both of the chassis and the second arm of the hinge.

According to another aspect of the present invention, there is provided a method of separating a chassis and a plasma display panel from a plasma display module that includes the plasma display panel, the chassis, and a hinge coupled to each of the chassis and the plasma display panel through an adhesive member. The method includes steps of decoupling the chassis from the hinge, and decoupling the hinge from the plasma display panel. The chassis is disposed adjacent to a rear surface of the plasma display panel and an image is displayed on the front surface.

The step of decoupling the chassis from the hinge may include a step of releasing a coupling member that couples a second arm of the hinge onto the chassis.

The method may further includes a step of removing the adhesive member from the plasma display panel.

According to the plasma display module described above, a chassis can be separated from a PDP of the plasma display module by unscrewing the screw which couple the hinge onto the chassis. Thus, a defect of the plasma display module can be repaired promptly and easily, and damage of the PDP through heating process can be prevented. Furthermore, the chassis can be reused.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view for describing a system for separating a chassis from a plasma display panel (PDP);

FIG. 2 is an exploded perspective view of a plasma display module constructed as an embodiment of the present invention;

FIG. 3 is a rear view of the plasma display module of FIG. 2 showing an arrangement of hinges, which is constructed as an embodiment of the present invention;

FIG. 4 is a rear view of a plasma display module of FIG. 2 showing another arrangement of hinges, which is constructed as another embodiment of the present invention;

FIG. 5 is a cross-sectional view of the plasma display module of FIG. 2, which is cut along line V-V;

FIG. 6 is a cross-sectional view of a hinge constructed as another embodiment of the present invention;

FIG. 7 is a cross-sectional view of a hinge constructed as another embodiment of the present invention;

FIG. 8 is a cross-sectional view of the plasma display module of FIG. 2, which is cut along line V-V, in order to illustrate a method for separating a chassis from a PDP, which is constructed as another embodiment of the present invention;

FIG. 9 is a flowchart of a method of combining a PDP and a chassis, which is constructed as an embodiment of the present invention; and

FIG. 10 is a flowchart of a method of separating a chassis from a PDP, which is constructed as another embodiment of the present invention.

### DETAILED DESCRIPTION OF THE INVENTION

Hereinafter, embodiments of the present invention will be described in detail with reference to the attached drawings.

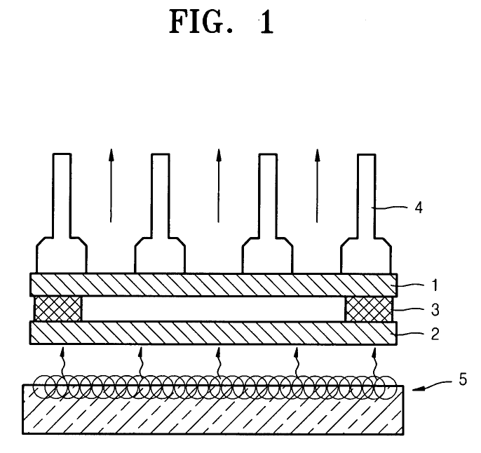

FIG. 1 is a schematic view for describing a system for separating chassis 2 from plasma display panel (PDP) 1. Referring to FIG. 1, plasma display module includes PDP 1, chassis 2, and double-sided tape 3 that connects chassis 2 to PDP 1. In order to separate chassis 2 from plasma display panel (PDP) 1, the plasma display module is arranged in a manner that PDP 1 is disposed upward. Heating lamp 5 is placed under the lower surface of the plasma display module (under chassis 2), and the plasma display module is heated up to 480° C. for 12 to 15 minutes by heating lamp 5. PDP 1 is lifted when the adhesive strength of double-sided tape 3 is weakened.

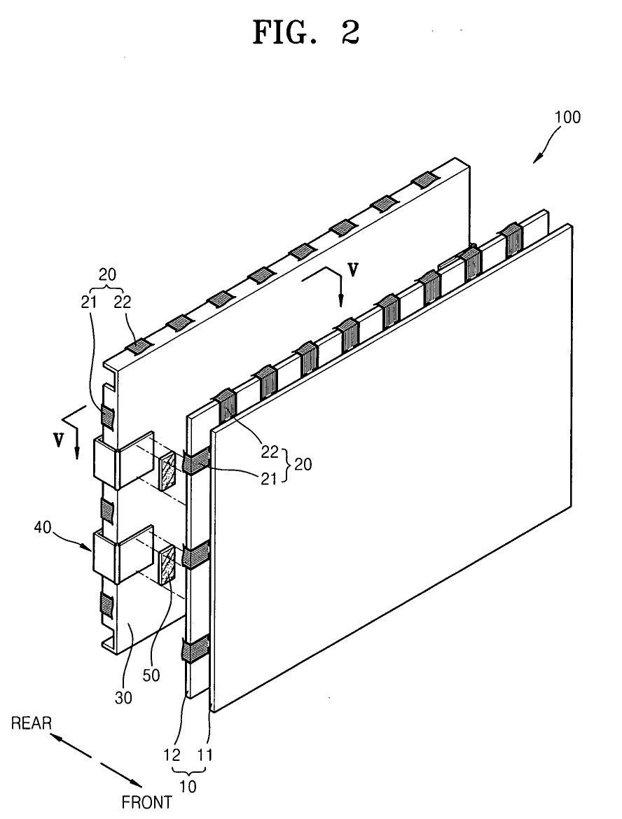

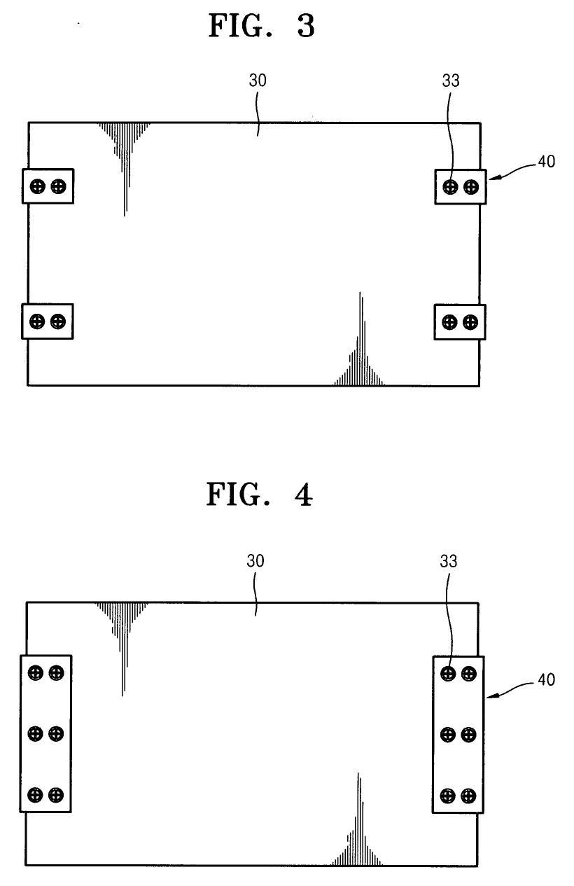

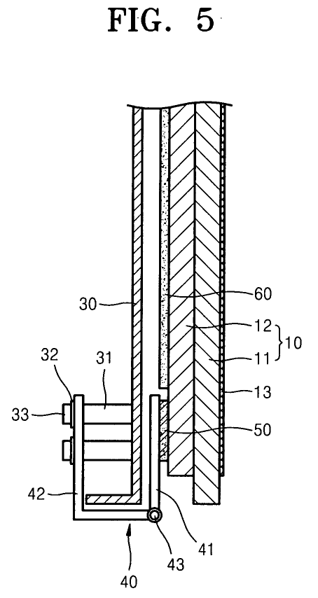

FIG. 2 is an exploded perspective view of a plasma display module 100 constructed as an embodiment of the present invention. FIG. 3 is a rear view of the plasma display module of FIG. 2 showing an arrangement of hinges, which is constructed as an embodiment of the present invention. FIG. 4 is a rear view of a plasma display module of FIG. 2 showing another arrangement of hinges, which is constructed as another embodiment of the present invention. FIG. 5 is a cross-sectional view of the plasma display module of FIG. 2, which is cut along line V-V shown in FIG. 2.

The plasma display module 100 of FIG. 2 includes plasma display panel (PDP) 10, chassis 30, a plurality of hinges 40, a plurality of adhesive members 50, heat sink sheet 60, a plurality of circuit boards (not shown), and a plurality of signal transmitting means 20.

PDP 10 is formed by combining front panel 11 and rear panel 12. Although not shown in FIG. 2, if PDP 10 is a 3-electrode surface discharge type, front panel 11 includes a front substrate, a plurality of pairs of sustain electrodes, a first dielectric layer, and a protection layer, and rear panel 12 includes a rear substrate, a plurality of address electrodes, a second dielectric layer, a fluorescent layer, and a barrier rib. Alternatively, PDP 10 may be a 2-electrode panel, a direct current (DC) type, or a double-substrate two-electrode type. When a predetermined pulse voltage is applied to PDP 10, a discharge occurs from each discharge cell, and thus ultraviolet (UV) rays are generated. The UV rays excite the fluorescent layer to generate visible light, and thereby PDP 10 displays an image.

PDP 10 is combined with chassis 30. In a method of combining PDP 10 and chassis 30, a double-sided tape, which can be one of adhesive members 50, can be directly attached between PDP 10 and chassis 30. In order to improve coupling and decoupling processes between PDP 10 and chassis 30, adhesive members 50, however, are not directly attached between PDP 10 and chassis 30 in the present invention. PDP 10 and chassis 30 are coupled to each other through hinges 40 and adhesive members 50 that are attached between PDP 10 and hinges 40. In more detail, pieces of adhesive members 50 are attached on a portion of a rear surface of PDP 10 that is closer to the lateral edges of the rear surface, for example, near the left or right edges of the rear surface of PDP 10. Here, the rear surface of PDP 10 is referred to as a surface of PDP 10 that does not display an image, while a front surface of PDP 10 is referred to as a surface that displays an image. The size and the number of the pieces of adhesive members 50 are determined in order that adhesive members 50 can sufficiently support PDP 10. According to the current embodiment, adhesive member 50 can be a double-sided tape, and two pieces of the double-sided tape are attached on each of the left and right portion of the rear surface of PDP 10. The present invention, however, is not limited thereto. One piece or more than three pieces of the double-sided tape can be attached on the rear surface of PDP 10, and any type of adhesives can be used as long as the adhesive is appropriate to hold the PDP and chassis.

Hinges 40 are coupled with chassis 30 in positions corresponding to the positions of the pieces of adhesive members 50. According to an embodiment of the present invention, each of hinges 40 may include pivot 43, first arm 41, and second arm 42. First arm 41 is a flat rectangular plate, and is attached on adhesive members 50. Second arm 42 is an L-shaped plate and is coupled with chassis 30 as shown in FIG. 5. Herein, the L-shaped plate means a flat plate bent at around right angle. Therefore, a cross-sectional view of the L-shaped plate has a L-shape. First and second arms 41 and 42 are connected to each other through pivot 43. Each of first arm 41 and second arm 42 has a first portion and a second portion. Each of the first portion of first arm 41 and the first portion of second arm 42 is rotatably connected to pivot 43. Adhesive member 50 is attached on the second portion of first arm 41, and the second portion of second arm 42 is coupled to the chassis.

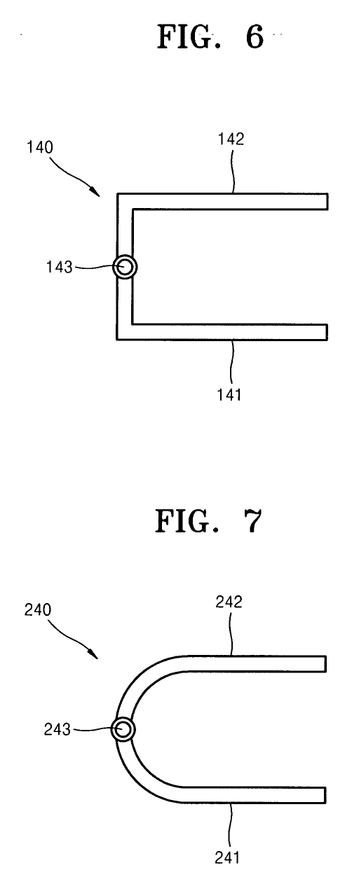

FIG. 6 shows cross-sectional view of hinge 140 that is constructed as another embodiment of the present invention. Referring to FIG. 6, hinge 140 may include first and second arms 141 and 142, each of which has a cross-sectional view of L-shape. First and second arms 141 and 142 are connected to each other by pivot 143.

FIG. 7 shows a cross-sectional view of hinge 240 that is constructed as another embodiment of the present invention. Referring to FIG. 7, hinge 240 includes first arm 241 second arm 242. A first portion of first arm 241 has a shape of an arc. A first portion of second arm 242 also may have a shape of an arc. The first portions of first and second arms 241 and 242 are connected to each other by pivot 243. Therefore, the coupled first portions of first and second arms 241 and 242 have a semicircle shape. In the present invention, the shape of the first arm and the shape of the second arm, however, can be different. For example, a first arm may have a L-shape, while a second arm may have an arc shape, depending on a design of a chassis and a plasma display module.

Referring to FIGS. 5, 6, and 7, hinges 40, 140 and 240 can be a thin and rigid plate such as an aluminum plate, a zinc-coated steel plate, or a steel plate. The size and the number of hinges 40, 140 and 240 are determined by the corresponding size and number of the pieces of adhesive members 50. For example, if two pieces of double-sided tapes (adhesive members 50) are attached on each of the left and right portions of the rear surface of PDP 10, two hinges (hinges 40, 140, or 240) are formed on positions corresponding to the positions of the pieces of the double-sided tapes. First portions of the hinges (hinges 40, 140, or 240) are attached on the pieces of the double-sided tapes, and second portions of the hinges are coupled with chassis 30.

The second portion of each of hinges (hinges 40, 140, or 240) and chassis 30 are coupled by a coupling member such as screw 33 and screw boss 31.

The coupling of the second portion of each of hinges 40 and chassis 30 will now be described in detail with reference to FIG. 5. Referring FIG. 5, screw boss 31 is formed on a rear surface of chassis 30 and screw 33 is coupled with screw boss 31. Herein a rear and front surfaces of chassis 30 are consistently defined the same directions as the rear and front surfaces of PDP 10. Therefore, the rear surface of PDP 10 faces the front surface of chassis 30. Screw 33 has a screw body and a screw head. The screw body passes through the second portion of hinge 40. An internal screw thread is formed inside screw boss 31 and screw body is coupled with the internal screw thread. Therefore, screw 33 can be coupled with screw boss 31. Also, in order to improve coupling strength, washer 32 can be included between the screw head of screw 33 and the second portion of hinge 40.

As shown in FIG. 3, two pairs of screw 33 and screw boss 31 can be formed in a horizontal direction (perpendicular to a lateral edge of PDP 10) at each of hinges 40 coupled to chassis 30. Here, the horizontal direction is referred to as a direction that is perpendicular to the lateral edge of PDP 10 as described referring to FIG. 2. Alternatively, as shown in FIG. 4, three sets of two pairs of screw 33 and screw boss 31, which are formed in a horizontal direction, can be formed in a vertical direction (parallel to a lateral edge of PDP 10) at each of hinges 40. FIGS. 3 and 4 show only examples how screw 33 and screw boss 31 can be arranged in a second portion of hinge 40, and the present invention is not limited to the arrangement shown in FIGS. 3 and 4. The number and the positions of screw 33 and screw boss 31 can vary in accordance with the size and the number of the pieces of adhesive member 50.

In this embodiment, the coupling by a pair of screw 33 and screw boss 31 is described, but the present invention is not limited thereto. A variety of coupling members, such as a one-touch locking device and a rivet, can also be used.

Heat sink sheet 60 can be disposed on the rear surface of PDP 10 in order to radiate heat generated by PDP 10. Filter 13 can be disposed on the front surface of PDP 10 in order to prevent reflection of external light and block electromagnetic waves. The circuit boards are combined to the rear surface of chassis 30. Although not shown in the drawings, the circuit boards may include a power supply board, a logic board, an address-electrode driving board, an X-electrode driving board, and a Y-electrode driving board. The address-electrode driving board, the X-electrode driving board and the Y-electrode driving board generate voltage pulses that are applied to the address electrodes, a plurality of X electrodes, and a plurality of Y electrodes, respectively. The generated voltage pulses are applied to each of the electrodes by signal transmitting means 20 such as tape carrier packages (TCPs) or flexible printed circuits (FPCs). Signal transmitting means 20 are included in PDP 10 by being electrically connected to electrode terminals of the PDP 10.

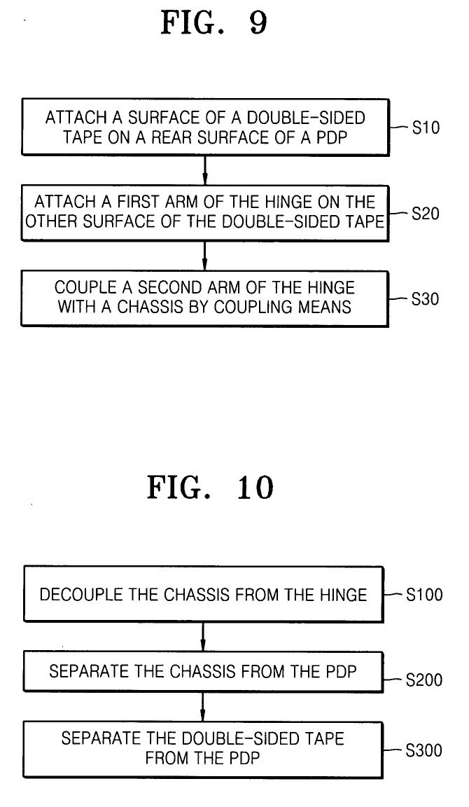

FIG. 9 is a flowchart of a method of combining a PDP and a chassis, constructed as an embodiment of the present invention. The flowchart of FIG. 9 will be described in referring to FIG. 5.

In step S10, a double-sided tape (adhesive member 50) is attached on the rear surface of PDP 10. A first surface of the double-sided tape is attached on the left and right portion of the rear surface of PDP 10. The size and the number of the pieces of the double-sided tape can vary as described above.

In step S20, a first portion of hinge 40 is attached on a second surface of the double-sided tape. Herein, the second surface of the double-sided tape is an opposite surface of the first surface of the double-sided tape. Then, in step S30, a second portion of hinge 40 is rotated about pivot 43, so that hinge 40 does not interfere with chassis 30 while being coupled with PDP 10. Chassis 30 is disposed behind PDP 10, and the second portion of hinge 40 is reversely rotated so as to be coupled with boss 31 fixed on chassis 30 using screw 33.

After PDP 10 and chassis 30 are combined as described above, the circuit boards of chassis 30 and a plurality of electrode terminals of PDP 10 are electrically connected by signal transmitting means 20 shown in FIG. 2, such as TCPs or FPCs. A plurality of X-electrode and Y-electrode signal transmitting means 21 may be connected through left and right side portions of PDP 10. Chassis 30 and a plurality of address electrode signal transmitting means 22 may be connected through top and bottom portions of PDP 10 and chassis 30. Assembly of the plasma display module 100 is completed during these steps.

When the assembly of plasma display module 100 is completed, inspection is performed on plasma display module 100 in order to investigate whether a defect has occurred. Because a plurality of integrated circuits (ICs) such as address-electrode driving chips are included in the TCPs, a defect may occur. If a defect is detected from the TCPs or FCPs during the inspection of plasma display module 100, chassis 30 has to be separated from plasma display module 100 in order to fix the defect.

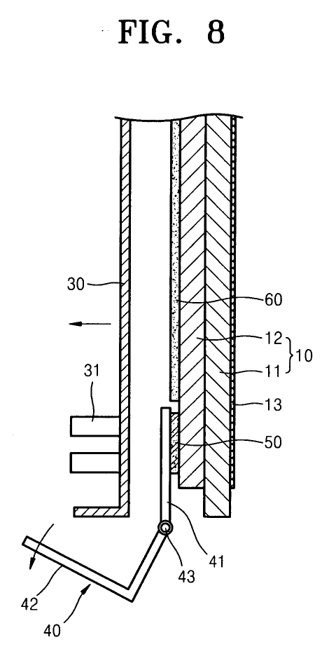

FIG. 8 is a cross-sectional view of plasma display module 100 of FIG. 2 cut along line V-V, when hinge 40 and chassis 30 are decoupled in order to separate PDP 10 from chassis 30, which is constructed as an embodiment of the present invention. FIG. 10 is a flowchart of a method for separating a chassis from a PDP, which is constructed as an embodiment of the present invention.

The flowchart of FIG. 10 will be described referring to FIG. 8. In step S100, screw 33 is unscrewed, so that a second portion of hinge 40 and chassis 30 are decoupled. Then, in step S200, the second portion of hinge 40 is rotated, so that hinge 40 does not interfere with chassis 30 while being separated from PDP 10. Chassis 30 is then separated from PDP 10.

In step S300, in order to separate hinge 40 from PDP 10, double-sided tape (adhesive member 50) is removed from PDP 10. Since the double-sided tape has high shear-strength and tensile-strength, the double-sided tape can be removed by peeling one end of the double-sided tape, while holding the end of the double-sided tape, and by pulling the double-sided tape towards the other end of the double-sided tape.

As described above, according to an embodiment of the present invention, a chassis can be separated from a PDP of a plasma display module by unscrewing a plurality of screws which couple a plurality of hinges onto a chassis. Thus, it is not necessary to heat the plasma display module in order to separate the chassis from the PDP. As a result, repair time is short, and damage of the PDP, due to the heat, can be prevented. Furthermore, the chassis can be reused.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope of the invention will be construed as being included in the present invention.

What is claimed is:

1. A plasma display module comprising:
a plasma display panel having a front surface and a rear surface, an image being displayed on the front surface;
a chassis arranged adjacent to the rear surface, the chassis being coupled to the plasma display-panel;
a hinge having a first arm and a second arm, the second arm being coupled to the chassis; and
an adhesive member disposed between the rear surface of the plasma display panel and the first arm of the hinge to attach the first arm of the hinge on the rear surface of the plasma display panel.

2. The plasma display module of claim 1, further comprising a coupling member that couples the second arm of the hinge onto the chassis.

3. The plasma display module of claim 2, comprised of the coupling member comprising:
a screw boss disposed between the second arm of the hinge and the chassis, the screw boss having an internal screw thread and being fixed on the chassis; and
a screw having a screw body and a screw head, the screw body passing through the second arm of the hinge and being coupled into the internal screw thread of the screw boss.

4. The plasma display module of claim 3, comprised of the coupling member further comprising a washer disposed between the screw head and the second arm of the hinge.

5. The plasma display module of claim 1, comprised of the adhesive member being attached on a lateral edge portion of the rear surface of the plasma display panel.

6. The plasma display module of claim 1, wherein only one adhesive member is attached on the first arm of the hinge.

7. The plasma display module of claim 1, comprised of the hinge comprising a pivot disposed between the first arm and the second arm, each of the first arm and the second arm having a first portion and a second portion, each of the first portion of the first arm and the first portion of the second arm being rotatably connected to the pivot, the adhesive member being attached on the second portion of the first arm, the second portion of the second arm being coupled to the chassis.

8. The plasma display module of claim 7, comprised of the first arm having a shape of a flat plate, and comprised of the second arm having a cross-sectional shape of an L-shape.

9. The plasma display module of claim 7, comprised of the first arm having a cross-sectional shape of an L-shape, and comprised of the second arm having a cross-sectional shape of an L-shape.

10. The plasma display module of claim 7, wherein the first portion of the first arm has a shape of an arc, the second portion of the first arm has a shape of a flat plate, the first portion of the second arm has a shape of an arc, and the second portion of the second arm has a shape of a flat plate.

11. The plasma display module of claim 1, comprised of the hinge being made of a material including aluminum.

12. A method of combining a plasma display panel and a chassis, the method comprising:
attaching a first surface of an adhesive member on a rear surface of the plasma display panel, an image being displayed on a front surface of the plasma display panel;
attaching a second surface of the adhesive member on a first arm of a hinge; and
coupling a second arm of the hinge onto the chassis.

13. The method of claim 12, comprised of the step of coupling the second arm of the hinge onto the chassis including a step of engaging a coupling member on both of the chassis and the second arm of the hinge.

14. The method of claim 13, comprised of the coupling member comprising:
a screw boss disposed between the second arm of the hinge and the chassis, the screw boss having an internal screw thread and being fixed on the chassis; and
a screw having a screw body and a screw head, the screw body passing through the second arm of the hinge and being coupled into the internal screw thread of the screw boss.

15. The method of claim 12, comprised of the adhesive member being attached on a lateral edge portion of the rear surface of the plasma display panel.

16. A method of separating a chassis and a plasma display panel from a plasma display module that includes the plasma display panel, the chassis, and a hinge coupled to each of the chassis and the plasma display panel through an adhesive member, the method comprising:
decoupling the chassis from the hinge, the chassis being disposed adjacent to a rear surface of the plasma display panel and an image being displayed on the front surface; and
decoupling the hinge from the plasma display panel.

17. The method of claim 16, comprised of the step of decoupling the chassis from the hinge including a step of releasing a coupling member that couples a second arm of the hinge onto the chassis.

18. The method of claim 17, comprised of the coupling member comprising:
a screw boss disposed between the second arm of the hinge and the chassis, the screw boss having an internal screw thread and being fixed on the chassis; and
a screw having a screw body and a screw head, the screw body passing through the second arm of the hinge and being coupled into the internal screw thread of the screw boss.

19. The method of claim 16, further comprising a step of removing the adhesive member from the plasma display panel.

20. The method of claim 16, comprised of the adhesive member being attached on a lateral edge portion of the rear surface of the plasma display panel.
